(19) United States
(12) Patent Application Publication
(10) Pub. No.: US 2025/0296446 A1
(43) Pub. Date: Sep. 25, 2025

(54) MOBILE MACHINE POWER CONDUCTOR LINKAGE SYSTEM FOR DYNAMIC ENERGY TRANSFER

(71) Applicant: Caterpillar Inc., Peoria, IL (US)

(72) Inventors: Igor STRASHNY, Tucson, AZ (US); Nitin R. PATEL, Tucson, AZ (US); Kurt L. WINCKLER, Tucson, AZ (US); Paul IVES, Twin Lake, MI (US)

(73) Assignee: Caterpillar Inc., Peoria, IL (US)

(21) Appl. No.: 19/228,242

(22) Filed: Jun. 4, 2025

Related U.S. Application Data
(63) Continuation-in-part of application No. 17/984,508, filed on Nov. 10, 2022.
(63) Continuation-in-part of application No. 18/524,234, filed on Nov. 30, 2023.
(60) Provisional application No. 63/657,157, filed on Jun. 7, 2024.

(51) Int. Cl. B60L 5/38

(52) U.S. Cl. CPC B60L 5/38; B60L 2200/36; B60L 2200/40

(57) ABSTRACT

A mobile machine power conductor linkage for receiving power from a power conductor rail assembly, comprising a movable conductor arm assembly. The movable conductor arm assembly may include a proximal portion including a first proximal end pivotably coupled to a mobile machine and a first distal end, and a distal portion including (i) a second proximal end pivotably coupled to the first distal end of the proximal portion and (ii) a second distal end extendable away from a side of the mobile machine. The side of the mobile machine may be located between a front end and a rear end of the mobile machine; and the movable conductor arm assembly may be movable between a retracted position and an extended position.

### CROSS-REFERENCE TO RELATED APPLICATION

This application (i) claims the benefit of priority to U.S. Provisional Patent Application No. 63/657,157, filed on Jun. 7, 2024, is (ii) a continuation-in-part of U.S. patent application Ser. No. 17/984,508, filed on Nov. 10, 2022, and (iii) a continuation-in-part of U.S. patent application Ser. No. 18/524,234, filed on Nov. 30, 2023, which are each herein incorporated by reference in their entirety.

### TECHNICAL FIELD

The present disclosure relates generally to an energy transfer system for a mobile machine, and more specifically, to a mobile machine power conductor linkage for receiving power from a power conductor rail assembly.

### BACKGROUND

Mobile industrial machines, such as earth-moving machines, can be of substantial weight and can bear immense loads, thus requiring a large amount of power. Many industrial machines are driven by internal combustion engines. However, internal combustion engines have drawbacks such as fuel costs, fuel transport difficulties, and detrimental engine emissions. Accordingly, there has been a movement toward powering large mobile industrial machines with hybrid or all-electric power systems.

While hybrid and all-electric power systems for industrial machines are beneficial for alleviating fuel costs and emission concerns, these systems present challenges. For example, the use of hybrid or all-electric systems in an industrial capacity requires a significant investment in infrastructure, particularly due to the location of industrial worksites. While the use of overhead electricity-conducting lines is one solution for powering vehicles with predetermined routes or terrain (e.g., trains, subways, buses, etc.), overhead lines are not practical for all machines or worksites, such as freely-steerable industrial machines and worksites with uneven terrain. As a result, existing power systems, such as overhead lines, are not typically used in remote and uneven environments. Other problems include the ability to safely deliver electricity to a moving industrial vehicle. It is therefore beneficial for industrial machines to have systems with the ability to quickly deploy or retract a connector assembly, either manually or automatically, with minimal, if any, assistance from the machine operator.

An electric deliver system for providing electric power to a traveling vehicle at a mine site or other industrial site presents unique challenges. For example, mobile machines are often extremely heavy, on the order of hundreds of tons, and mounting an electrical delivery system to such a heavy machine may compromise the structural integrity or the operability of the mobile machine. In some cases, an electrical delivery system at a mine site for a moving vehicle may include two conductors anchored to relocatable roadside barriers. In order to charge the moving vehicle, such a delivery system requires a retractable arm to precisely engage with electrical connectors embedded within a horizontal channel of the roadside barriers. A retractable arm of an electrical delivery system for a heavy industrial mobile machine needs to be precisely mounted to the mobile machine to both easily connect the electrical delivery system to the roadside electrical conductors and not disrupt the operability of the mobile machine.

Aspects of the present disclosure may solve one or more of the problems set forth above and/or other problems in the art. The scope of the current disclosure, however, is defined by the attached claims, and not by the ability to solve any specific problem.

### SUMMARY

In one aspect, a mobile machine power conductor linkage for receiving power from a power conductor rail assembly, comprising a movable conductor arm assembly. The movable conductor arm assembly may include a proximal portion including a first proximal end pivotably coupled to a mobile machine and a first distal end, and a distal portion including (i) a second proximal end pivotably coupled to the first distal end of the proximal portion and (ii) a second distal end extendable away from a side of the mobile machine. The side of the mobile machine may be located between a front end and a rear end of the mobile machine; and the movable conductor arm assembly may be movable between a retracted position and an extended position.

In another aspect, a method of operating a rail connector assembly of a mobile machine, such as a mobile machine power conductor linkage, may include receiving a request to extend the rail connector assembly, which includes a boom, a trailing arm assembly, and a contactor assembly, from a frame of the mobile machine and a request to extend the trailing arm assembly to electrically connect to a plurality of conductor rails. The method may also include generating movement commands to operate the rail connector assembly and determining a presence of electrical energy along the plurality of conductor rails using a continuity sensor connected to the contactor assembly.

In another aspect, a mobile machine power system may include an electronic control module with an input receiver, a plurality of sensors, and a rail connector assembly with a boom, an arm assembly, and a contactor assembly. The rail connector assembly may be configured to connect with a plurality of conductor rails and the input receiver may receive input to extend the rail connector assembly from a frame of a mobile machine. The electronic control module may be configured to generate commands to extend the boom and the arm assembly.

In yet another aspect, a method of disconnecting a connector assembly of a mobile machine from a plurality of conductor rails may include receiving, by a control system, an operator input to disengage the connector assembly from the plurality of conductor rails and generating connector assembly commands, through the control system. The connector assembly commands may include a first command for controlling a plurality of magnets and a plurality of extendable brushes of the contactor assembly, a second command for controlling the trailing arm assembly, and a third command for controlling a hydraulic system of the boom. The method may also include securing the connector assembly to a frame of the mobile machine.

In another aspect, a power rail connector for an electric power system in a machine includes a linkage having a lower link, an upper link, a fold joint connecting the lower link to the upper link, a fold actuator coupled between the upper link and the lower link, a pivot, a lift joint connecting the pivot to the upper link, and a lift actuator coupled between the pivot and the upper link. The power rail connector further includes a rail contactor coupled to the lower link and including electrical contacts positioned to electrically connect to a power rail. The fold joint defines a horizontally extending fold axis, the lift joint defines a horizontally extending lift axis, and the pivot defines a vertically extending pivot axis. The linkage is adjustable from an extended, current-collecting configuration to a collapsed configuration via rotation of the lower link relative to the upper link about the fold axis and rotation of the upper link relative to the pivot about the lift axis.

In another aspect, an electric machine includes a frame having a front frame end and a back frame end, and ground-engaging propulsion elements coupled to the frame. The electric machine further includes an electric power system having an electric motor, and a power rail connector including a support arm having an inboard arm end coupled to the frame, and an outboard arm end, and a linkage supported on the outboard arm end. The linkage includes a lower link, an upper link, a fold joint connecting the lower link to the upper link and defining a fold axis, a pivot defining a pivot axis, a lift joint connecting the pivot to the upper link and defining a lift axis, and a rail contactor coupled to the lower link. The support arm is movable from a stowed position relative to the frame, to a service position at which the outboard arm end is faced laterally outward of the frame. The linkage is adjustable from an extended, current-collecting configuration to a collapsed configuration via rotation of the lower link relative to the upper link about the fold axis and rotation of the upper link relative to the pivot about the lift axis.

In still another aspect, a method of operating a machine includes moving a support arm coupled to a frame in a machine from a stowed position to a service position extending onboard from the frame, and adjusting a linkage of a power rail connector from a collapsed configuration to an extended, current collecting configuration via unfolding the linkage at a fold joint, and lowering the linkage at a lift joint. The method further includes aligning a rail contact or laterally with a power rail, based on an at least one of an angular orientation of the linkage relative to the support arm or a lateral position of the support arm relative to the frame, and contacting the rail contactor to the power rail to electrically connect an electric power system of the machine to the power rail.

In another aspect, a mobile machine power conductor linkage for receiving power from a power conductor rail assembly may comprise a movable conductor arm assembly. The movable conduct arm assembly may include a proximal portion including a first proximal end pivotably coupled to a mobile machine and a first distal end, and a distal portion including (i) a second proximal end pivotably coupled to the first distal end of the proximal portion and (ii) a second distal end extendable away from a side of the mobile machine, the side of the mobile machine being located between a front end and a rear end of the mobile machine. The movable conductor arm assembly may be movable between a retracted position and an extended position.

In another aspect, a mobile machine power conductor linkage for receiving power from a power conductor rail assembly may comprise a movable conductor arm assembly. The movable conduct arm assembly may include a proximal portion including a first proximal end pivotably coupled to a mobile machine and a first distal end, and the first proximal end is pivotably coupled to a portion of the mobile machine vertically between at least one tire of the mobile machine and a floor of an operator cabin. The movable conductor arm assembly may be movable between a retracted position and an extended position, and the movable conductor arm assembly is extended away from a side of the mobile machine in the extended position. The side of the mobile machine may be located between a front end and a rear end of the mobile machine.

In another aspect, a mobile machine power conductor linkage for receiving power from a power conductor rail assembly may comprise a movable conductor arm assembly. The movable conduct arm assembly may include a proximal portion including a first proximal end pivotably coupled to a mobile machine and a first distal end, wherein the first proximal end is pivotably coupled to a portion of the mobile machine longitudinally between a center of a front wheel and a center of a rear wheel, and the movable conductor arm assembly being movable between a retracted position and an extended position. The movable conductor arm assembly is extended away from a side of the mobile machine in the extended position, the side of the mobile machine being located between a front end and a rear end of the mobile machine.

In another aspect, a mobile machine power conductor linkage for receiving power from a power conductor rail assembly may comprise a movable conductor arm assembly. The moveable conductor arm assembly may include a proximal portion including a first proximal end pivotably coupled to a mobile machine and a first distal end, the movable conductor arm assembly being movable between a retracted position and an extended position. The movable conductor arm assembly may be extended away from a side of the mobile machine in the extended position, the side of the mobile machine being located between a front end and a rear end of the mobile machine. The first distal end may be vertically higher than the first proximal end in the extended position.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 is a perspective view of an electric mobile machine connected to a conducting rail power source via a deployed connector assembly, according to aspects of this disclosure.

FIG. 2 is a side view of the electric mobile machine with the connector assembly in a retracted stowed state, according to aspects of this disclosure.

FIG. 3 is a side view of the electric mobile machine with a boom of the connector assembly extended and a trailing arm of the connector assembly in a retracted state, according to aspects of this disclosure.

FIG. 4 is a side view of the electric mobile machine with the connector assembly engaged with the conducting rail power source, according to aspects of this disclosure.

FIG. 5 is a cross-sectional view of conductor terminals housed within the contactor assembly, according to aspects of this disclosure.

FIG. 6 is block diagram of an exemplary machine control system, according to aspects of this disclosure.

FIG. 7 is a flowchart illustrating a method for controlling a rail connector assembly, according to aspects of this disclosure.

FIG. 8 is a diagrammatic view of an electric machine, according to aspects of this disclosure.

FIG. 9 is a diagrammatic view of a power rail connector in a collapsed configuration, according to aspects of this disclosure.

FIG. 10 is a diagrammatic view of a power rail connector in an extended, current-collecting configuration, according to aspects of this disclosure.

FIG. 11 is another diagrammatic view of a power rail connector in a collapsed configuration, according to aspects of this disclosure.

FIG. 12 is another diagrammatic view rotated approximately 180° relative to FIG. 11, of a power rail connector as in FIG. 11, according to aspects of this disclosure.

FIG. 13 is a diagrammatic view of a power rail connector at one stage of deployment, according to aspects of this disclosure.

FIG. 14 is a diagrammatic view of a power rail connector at another stage of deployment, according to aspects of this disclosure.

FIG. 15 is a diagrammatic view of a power rail connector at yet another stage of deployment electrically contacting a power rail, according to aspects of this disclosure.

FIG. 16 is a perspective view of a power rail connector coupled to a mobile machine and in a retracted configuration, according to aspects of this disclosure.

FIG. 17 is a perspective view of a power rail connector coupled to a mobile machine and in an extended configuration, according to aspects of this disclosure.

FIG. 18 is a side view of a power rail connector coupled to a mobile machine and in a retracted configuration, according to aspects of this disclosure.

FIG. 19 is a top view of a power rail connector coupled to a mobile machine and in a retracted configuration, according to aspects of this disclosure.

### DETAILED DESCRIPTION

Both the foregoing general description and the following detailed description are exemplary and explanatory only and are not restrictive of the features, as claimed. As used herein, the terms “comprises,” “comprising,” “has,” “having,” “includes,” “including,” or other variations thereof, are intended to cover a non-exclusive inclusion such that a process, method, article, or apparatus that comprises a list of elements does not include only those elements, but may include other elements not expressly listed or inherent to such a process, method, article, or apparatus. In this disclosure, unless stated otherwise, relative terms, such as, for example, “about,” “substantially,” and “approximately” are used to indicate a possible variation of ±10% in the stated value.

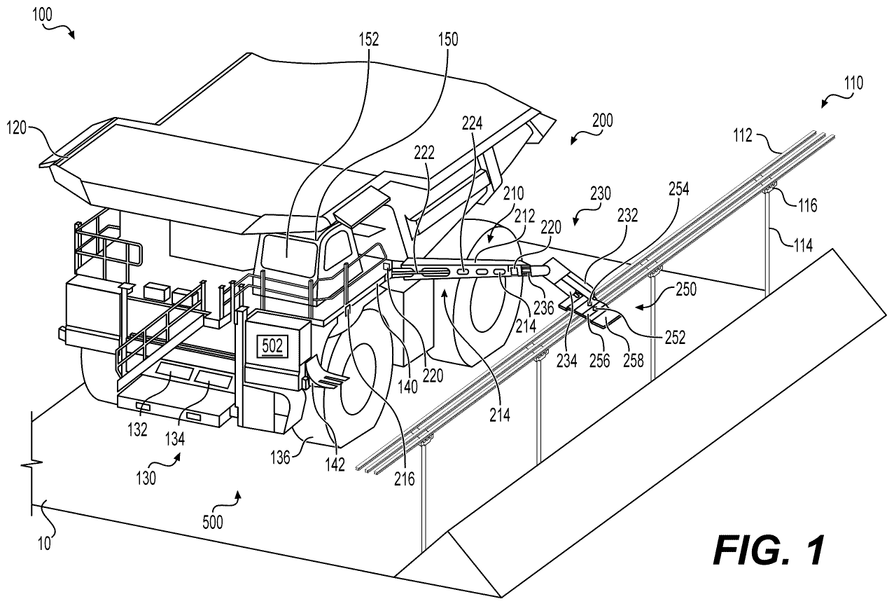

FIG. 1 depicts a mobile machine power system 100, according to aspects of the present disclosure. The mobile machine power system 100 includes an electrically-conducting rail system 110, a mobile machine 120 having a rail connector assembly 200, and a control system 500 including one or more sensors and an electronic control module (“ECM”) 502. The mobile machine 120 is free-steering and includes an electric drive system 130 having at least one electric motor 132 and at least one battery system 134.

The electric drive system 130 rotates a set of ground-engaging elements 136, such as tires or continuous tracks, for propelling and maneuvering the mobile machine 120. The mobile machine 120 also includes a frame 140 and an external shelf 142. The external shelf 142 serves as a storage platform for the trailing arm assembly 230 and the contactor assembly 250 and may be made of steel or any other appropriate magnetic material.

When in operation, the mobile machine 120 and its various systems are controlled via a machine operator located in the operator cabin 150, which may include a plurality of position indicators 152 presented within cabin 150. Examples of position indicators 152 include camera feeds, turn signal indicators, systemic representations or images of the position of the rail connector assembly 200 in relation to the electrically-conducting rail system 110, and others. Displays within the operator cabin 150 may display the position indicators 152 as well as system data or other visual feedback.

As shown in FIG. 1, the mobile machine 120 can be a mining truck, such as a haul truck utilized for transporting material in an opencast mine environment. The present disclosure is not thereby limited, however, and other types of machines are within the scope of the present disclosure, including articulated trucks, asphalt pavers, backhoe loaders, cold planers, compactors, dozers, draglines, drills, rope shovels, excavators, forest machines, hydraulic mining shovels, material handlers, motor graders, off-highway trucks, pipelayers, road reclaimers, skid steer and compact track loaders, telehandlers, track loaders, underground mining loaders and trucks, wheel loaders, or other similar vehicles. It may be appreciated by one having skill in the art that mobile machine 120 may utilize either hybrid or all-electric power systems, and the electrically-conducting rail system 110 may be applied to either system.

The exemplary mobile machine 120 is configured to travel (e.g., in a free-steering manner) along a work route or path, the electrically-conducting rail system 110 being positioned generally parallel to the route or path. The electrically-conducting rail system 110 of FIG. 1 includes a plurality of conductor rails 112 connected to a power-generating source (e.g., a power grid, generator, and/or energy storage devices), a plurality of support poles 114 secured to the ground 10, and a bracket assembly 116 attached to a top end of the each of the support poles 114 to retain the plurality of conducting rails 112 in a secured elevated position. While FIG. 1 shows an example where the plurality of conductor rails 112 contains three conductor rails, fewer or more rails 112 are possible. In this example, two of the conductor rails provide electrical power at different polarities while the third conductor rail provides a reference of 0 volts. The electrically conducting rail system may alternatively incorporate a three-phase power system, utilizing a three-rail power circuit in addition to a fourth conductor rail providing a reference of 0 volts.

The plurality of support poles 114 ground the electrically-conducting rail system 110, specifically contacting the conductor rail 112 that provides a reference of 0 volts. Individual support poles 114 may be rods, poles, posts, cylinders, stanchions, or similar structures and have a length for elevating and supporting the plurality of conductor rails 112. The plurality of support poles 114 may each have a length sufficient to support and stabilize the plurality of conducting rails 112 at a height of at least eight feet above the ground, for example. The support poles 114 are made of dielectric materials such as pultruded fiberglass-reinforced polymer (FRP), or other electrically insulating or dielectric materials.

To electrically connect the mobile machine 120 to the electrically-conducting rail system 110, the mobile machine 120 includes rail connector assembly 200, which includes a boom 210, a trailing arm assembly 230, and a contactor assembly 250. The boom 210 includes a housing 212 with a busbar assembly extending the length of the boom (not shown). The boom 210 also includes a hydraulic system 214 within the housing. The boom 210 is pivotally attached to a side surface of the frame 140 at a proximal end of the boom 210. The boom 210 pivots towards or away from the frame via the hydraulic system 214. The housing 212, which provides protection to the internal components of the boom 210, may be substantially parallelepiped and fabricated from a metal material (e.g., steel) or other suitable material. While the boom 210 is shown to be attached to a mining haul truck, the boom 210 may be incorporated in various types of mobile machines 120 by use of an interchangeable adapter (not shown), attached to the housing 212 that is specific to the type of machine being operated.

The housing 212 includes a plurality of maintenance openings 224 (FIG. 1) located along the length of the boom 210. The maintenance openings 224 allow for easy access to the internal systems of the boom 210 without the need to completely detach the boom 210 from the mobile machine 120. For example, the maintenance openings 224 allow for an operator or a mechanic to replace components of the hydraulic system 214 or the pneumatic system 236, and also ensure the proper connection of the busbar assembly within the boom 210.

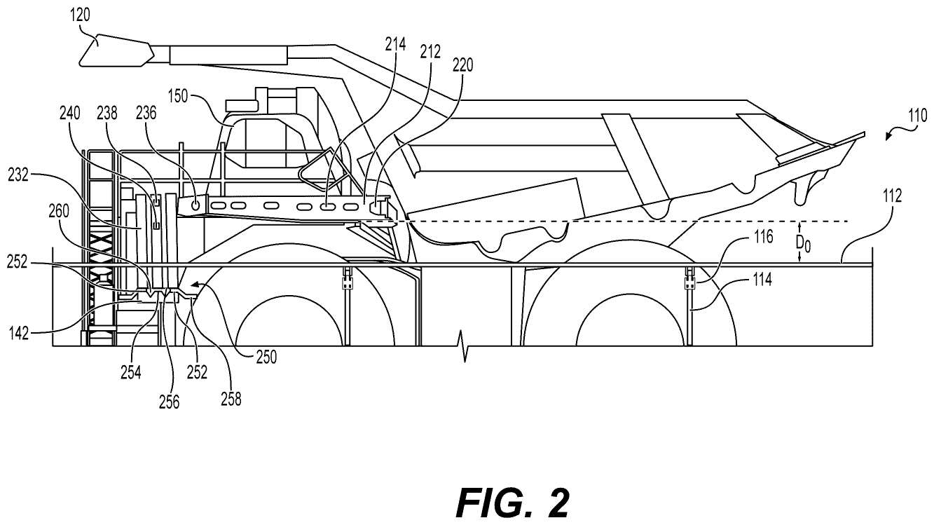

The boom 210 includes several different states, such as an extended state (shown in FIGS. 1, 3, and 4) in which the boom is extended away from the mobile machine, a retracted state (shown in FIG. 2) in which the boom is rotated inward to rest against the frame 140 of the mobile machine, and a locked state (also shown in FIG. 2) in which the boom is locked to the side of the frame in the retracted state. As shown in FIG. 1, when in an extended state, the boom 210 is pivoted outward from the mobile machine 120 in a horizontal direction so that the boom is normal to the mobile machine 120 or angled upward or downward, such as angled slightly upward as shown in FIGS. 1, 3, and 4. As shown in FIGS. 1-4, the boom 210 is attached to the frame 140 of the mobile machine 120 at a height greater than the height of the conductor rails 112. The distance between the height of the boom and the height of the conductor rails 112 is represented by distance D₀ (FIG. 2).

When in a locked state, a locking pin on the boom 210 is actuated into a locked state and the boom 210 is secured in the retracted state (FIG. 2). When initiating an unlock sequence, the locking pin on the boom 210 is actuated to an open or free position, which allows for the boom, though still in the retracted state, to be manipulated or positioned by a user. This unlocked, yet retracted position may aid in servicing the connector assembly 200 and allow for the removal or integration of additional components.

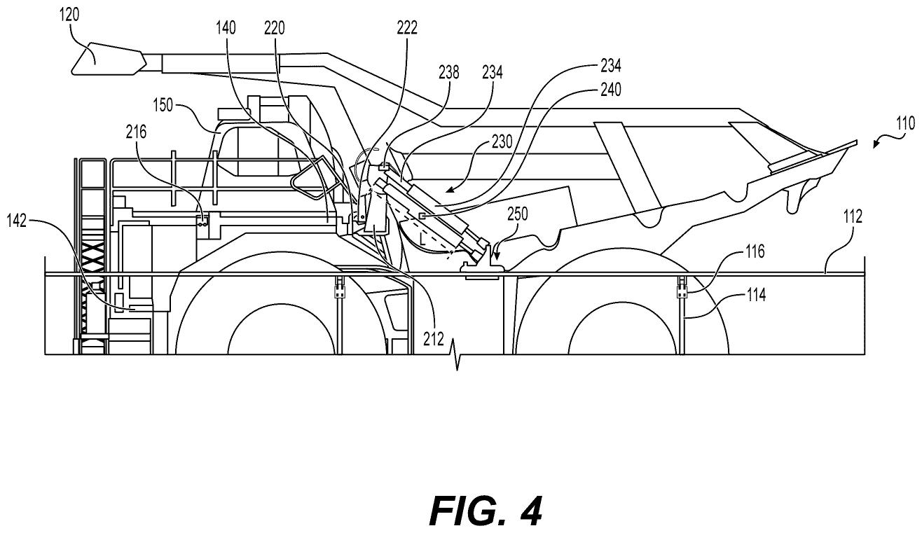

FIG. 1 also depicts the trailing arm assembly 230 attached to a distal end of the boom 210 by a connection (not shown) that allows for the movement of the plurality of trailing arms 232 (best shown in FIG. 4) with two degrees of freedom (e.g., movement in a horizontal direction and movement in a vertical direction) independent of the movement of the boom 210. The multiple degrees of freedom provide the connector assembly 200 with lateral and vertical freedom to adjust to the electrically-conducting rail system 110 during use of the mobile machine 120. More specifically, the trailing arm assembly 230 accommodates changes in relative position between plurality of conductor rails 112 and mobile machine 120 (e.g., increases or decreases to distance D₀) during travel.

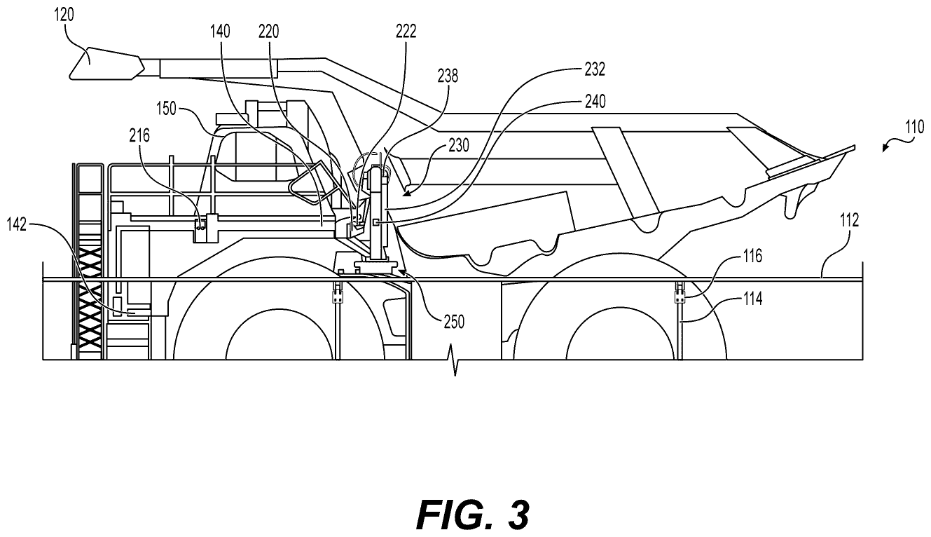

With reference to FIG. 4, each of the trailing arms 232 includes a plurality of telescoping links 234 with connection sockets (not shown), housed within the plurality of telescoping links, for the extension and retraction between the different states of the trailing arm assembly. In operation, the trailing arm assembly 230 is capable of multiple configurations or states, including a fully-extended state (shown in FIGS. 1 and 4), a stowed state (shown in FIG. 2) in which the trailing arm assembly 230 is slightly extended to place the contactor assembly 250 in contact with the shelf 142, and a retracted state (shown in FIG. 3) in which the trailing arm assembly is retracted to allow the contactor assembly 250 to be free of the shelf and the trailing arm assembly is positioned above the conductor rails 112. In the retracted state (shown in FIG. 3), the contactor assembly 250 is not attached or in contact with the conductor rails 112.

The contactor assembly 250 includes a base frame 256 in which a plurality of conducting terminals 262 are secured. In an exemplary configuration, nine conducting terminals 262 are arranged in a three-by-three matrix to provide redundancy and maintain electrical connection with the conductor rails 112; however, the conducting terminals 262 may be arranged in different quantities and in other configurations. In the exemplary rail configuration of three conductor rails 112 and utilizing the three-by-three conducting terminal matrix, the plurality of conducting terminals 262 are split into three equal groups of three conducting terminals arranged in a linear fashion. The three groups of linear conducting terminals 262 each correspond to one of the positive polarity conductor rail, the negative polarity conductor rail, and the conductor rail providing a reference of 0 volts.

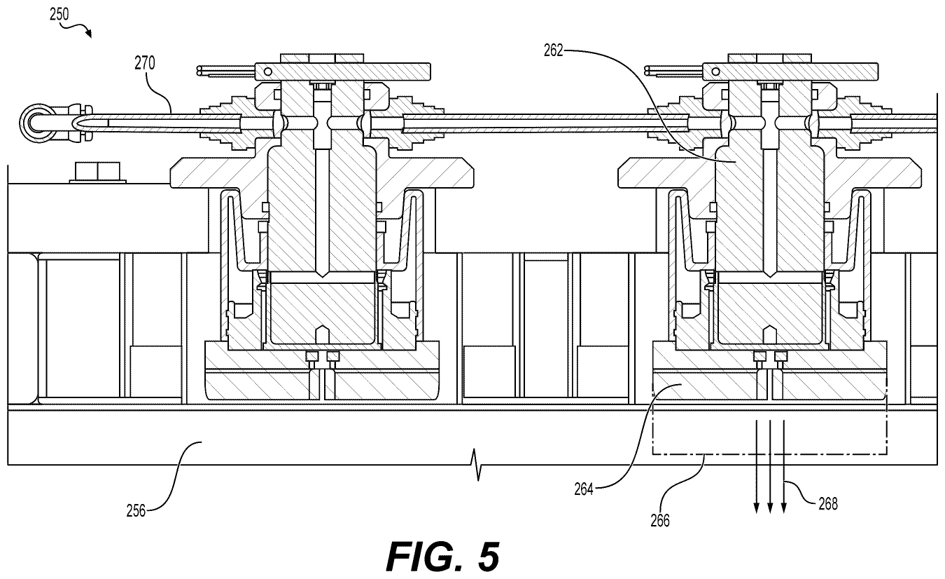

As shown in FIG. 5, each individual conducting terminal 262 is fluidly connected to the pneumatic system 236 of the trailing arm assembly 230 via a conduit 270, with each of the conducting terminals 262 further including a plurality of magnets (not shown) and an extendable brush 264. The contactor assembly 250 further includes several retaining features for maintaining the connection of contactor assembly 250 with the plurality of conductor rails 112. For example, the base frame 256 includes a pair of lower flanges 258 (FIG. 2) located on opposite lateral sides of the base frame 256, as well as a pair of bumpers 260 that separate the respective groups of conducting terminals 262 from each other. Individual groups of conducting terminals 262 align with the individual conductor rails 112, and the individual bumpers 260 align with gaps located between the conductor rails 112.

While the trailing arm assembly 230 provides multiple degrees of freedom and movement in horizontal and vertical directions, the contactor assembly 250 generally may be restricted to pivoting movement about the distal end of the trailing arm assembly 230. Providing restrictions to movement may help prevent a glancing or unstable connection with the conductor rails 112 and provides the power system 100 with a stable platform to connect to the electrically-conducting rail system 110.

The connector assembly 200 of the mobile machine 120 is configured to be electrically connected to the electrically-conducting rail system 110. For example, the contactor assembly 250 provides an electrical connection via the plurality of conducting terminals 262, allowing the electrical energy to be transmitted from the contactor assembly 250 to the trailing arm assembly 230. The electrical energy is then routed from the fully-extended trailing arm assembly 230, as shown in FIG. 1, to the busbar assembly within the boom 210, which is then transferred to the motor 132 and/or battery system 134.

As best shown in FIG. 1, the connector assembly 200 may be controlled by the control system 500, which may be controlled by an operator or may be automatically generated. In the illustrated configuration, the control system 500 includes the ECM 502 and one or more sensors that provide angular, linear, rotary, and proximity feedback or other information, as inputs to ECM 502. The sensors of control system 500 may include lock sensor 216 that generates a lock signal 514, angle sensor 220 that generates an angle signal 516, hydraulic sensors 222 that generate a hydraulic signal 518, trailing arm position sensors 238 that generate a position signal 520, pneumatic sensors 240 that generate a pneumatic signal 522, voltage sensors 252 that generate a voltage signal 524, and/or ground sensors 254 that generate a ground signal 526.

The lock sensor 216 (best shown in FIG. 1) is attached to the frame 140 of the mobile machine 120. The lock sensor 216 is configured to sense the proximity of the boom relative to the side of the mobile machine 120. The angle sensor 220 (best shown in FIG. 1) for the boom 210 is located at or near the attachment point between the frame 140 and the proximal end of the boom. The angle sensor 220 provides the ECM 502 with angular data corresponding to whether the boom 210 is fully extended (FIG. 1) or whether the boom is retracted against the mobile machine (FIG. 2). Additionally, the hydraulic sensors 222 on the boom 210 provide rotary data to the ECM 502 which may correspond to control of the hydraulic components housed within the boom, the actuation of hydraulic cylinders, and the rotational movement of the boom.

The trailing arm assembly 230 may include one or more position sensors 238 (FIGS. 2-4), with position sensor(s) 238 being housed within each trailing arm 232. The position sensor(s) 238 provide(s) vertical and horizontal location information of the trailing arms 232 to the ECM 502 and is used to indicate the alignment of the trailing arm assembly 230 with the electrically-conducting rail system 110, and specifically the conductor rails 112. The trailing arm assembly 230 also includes pneumatic sensors 240 (FIGS. 2-4) for regulating the extension and retraction of the trailing arms and for engaging or disengaging of the contactor assembly 250 with the conductor rails 112.

Contactor assembly 250 further includes a plurality of voltage sensors 252 and a plurality of ground sensors 254 (collectively referred to as “continuity sensors”). The continuity sensors are in electrical communication with the plurality of conducting terminals 262 of the contactor assembly 250 and provide the ECM 502 with voltage information or other related data. If desired, the data from the continuity sensors can be provided in a continuous (e.g., real-time) manner. For example, during operation in an exemplary configuration, individual groups of three conducting terminals 262 are arranged in a line. The continuity sensors 252, 254 for the individual groups of three conducting terminals 262 continuously test for the presence of a voltage or ground (e.g., the reference of 0 volts) on its respective conductor rail 112. More specifically, for each group of three conducting terminals 262, the first two conducting terminals 262 test for the presence of voltage or ground at a transition between the current section of an individual conductor rail 112 and a new section of another conductor rail 112, while the remaining conducting terminal confirms the presence of voltage or ground on the current section of rail. The data provided by the continuity sensors may correspond to commands from the ECM 502 relating to the engagement of the contactor assembly 250, the reaction of the pneumatic system 236 to disengage the brushes 264, and the transfer of electrical energy from the conductor rails 112 to the battery system 134 of the mobile machine 120.

ECM 502 may be made of a single physical module or may include multiple physical modules with each module relating to a specific task or function. ECM 502 may include a single microprocessor or multiple microprocessors configured to receive inputs and generate outputs in the form of commands to control the operation of components of the connector assembly 200. The ECM 502 may include programming to calculate the optimal operation of the conductor assembly 200, to generate outputs to be executed by the connector assembly 200 and/or other components of the machine 120, and to perform the functions described herein.

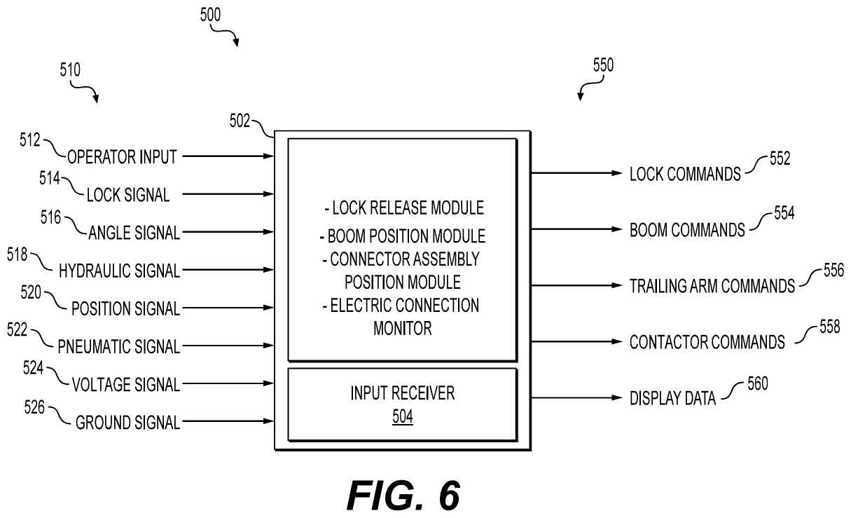

FIG. 6 is a block diagram illustrating an exemplary configuration of the control system 500, including the ECM 502, which may be programmed to perform the functions of a lock release module, a boom position module, a connector assembly position module, and an electric connection monitor, as described below. Inputs 510 are received by an input receiver 504 of the ECM 502 from the above described sensors. The inputs 510 may include operator inputs 512 from input devices (e.g., joysticks, pedals, control buttons, switches, etc.), preprogrammed sequences or routines for the mobile machine, boom sensor information (e.g., the lock signal 514, the angle signal 516, and the hydraulic signal 518), trailing arm data inputs (e.g., the position signal 520, the pneumatic signal 522), and continuity sensor information (e.g., voltage signal 524 and ground signal 526) obtained from the contactor assembly.

The outputs 550, as shown in FIG. 6, may also include a notification, such as an in-cabin indicators. Outputs 550 generated by the control system 500 may also include lock commands 552 for the locking pin, boom commands 554 for the hydraulic system 214, trailing arm assembly commands 556 for the pneumatic system 236 (thereby controlling the plurality of telescoping links 234 of the plurality of trailing arms 232), connector assembly commands 558 for the pneumatic system 236 (thereby controlling the plurality of extendable brushes 264), and data display commands 560, as described below.

The disclosed aspects of the control system above can be used for deploying and controlling a rail connector assembly while charging a free-steering mobile machine with an electrically-conducting rail system on a worksite. For example, the drawings illustrate the connector assembly in various states of engagement with the electrically-conducting rail system and a block representation of the rail connector control system.

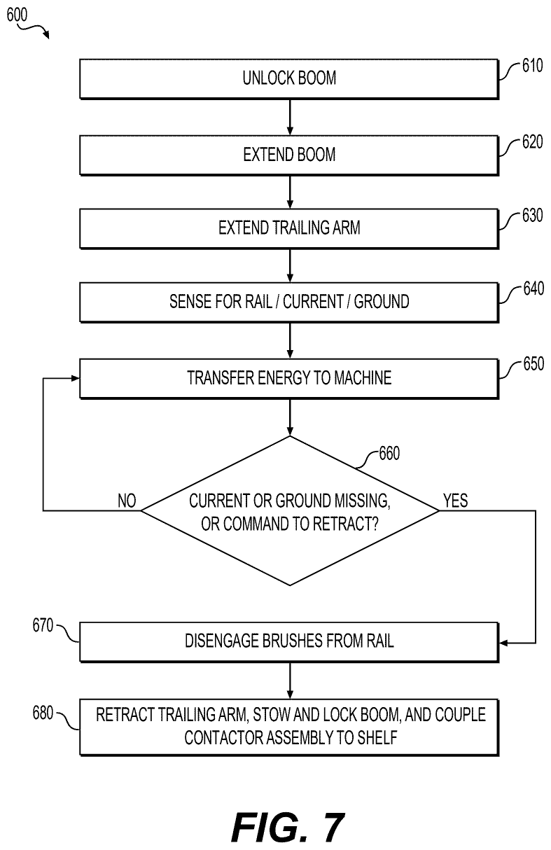

FIG. 7 is a flowchart illustrating an exemplary method 600 for operating a connector assembly 200 of a mobile machine power system 100 according to aspects of the present disclosure. Prior to the performance of method 600, the connector assembly 200 may be in the state shown in FIG. 2. While in this locked state, the trailing arm assembly 230 and the contactor assembly 250 are retained on the shelf 142 (FIG. 2) due to the magnetic force generated by the magnets (not shown) housed within the base frame 256 and the combined mass of the trailing arm assembly and the contactor assembly. The trailing arm assembly 230 and the contactor assembly are oriented in a vertical direction relative to the ground 10. Also, prior to unlocking the boom 210, the lock sensor 216 (FIG. 1) provides a signal 514 to the control system 500 indicating that the locking pin is in a locked state.

Step 610 may include unlocking the boom 210 from the frame 140 of the mobile machine 120. For example, the ECM 502 receives a request to extend the rail connector assembly 200 (e.g., including a request to extend the trailing arm assembly 230), determines that the boom 210 is locked, and in response initiates an unlock or open command 552 to an actuator for the locking pin, thereby moving the locking pin into an open or free position. The request to extend the rail connector assembly and the request to extend the trailing arm assembly may be a single request generated by an operator pushing a button in the operator cabin 150 or may be automatically generated based on a geographic location of the machine 120 as determined by a Global Navigation Satellite System (“GNSS”).

As a part of step 610 or in a subsequent step, a trailing arm command 556 may be generated with the ECM 502 to cause the plurality of telescoping links 234 to retract from the stowed state (FIG. 2) to the retracted state (FIG. 3). The ECM 502 initiates a contactor assembly command 558, signaling to the pneumatic system to provide fluid pressure to actuate the extendable brushes 264 in the contactor assembly. As shown in FIG. 5, the retraction of the trailing arms away from the shelf 142 and the extension 266 of the extendable brushes 264 in a direction 268 (in opposition to the shelf 142) results in a force greater than the combined gravitational and magnetic forces necessary to keep the contactor assembly 250 on the shelf, transitioning from the stowed state in which the contactor assembly 250 rests on the shelf 142 into the retracted state, in which the trailing arm assembly 230 is slightly retracted from the shelf 142 and the combination of the trailing arm assembly and the contactor assembly are capable of freely travelling in conjunction with the boom 210.

Step 620 of the method 600 may include extending the boom 210 from the retracted state by generating a boom command 554 to extend the boom from a retracted state to the fully-extended state as shown in FIG. 1. Step 620 may be performed in response to receiving operator input 512 by the inputs receiver 504 for extending the rail connector assembly 200. The ECM 502 provides a boom command 554 to the hydraulic system 214 in Step 620, signaling for the extension of the boom 210 outward from the side of the mobile machine 120. As the boom 210 is extended, the retracted trailing arm assembly 230 is rotated outward at a distal end of the boom and is oriented in a vertical direction relative to the ground 10, as shown in FIG. 3. When the boom 210 has been fully extended, the angle sensor 220 provides an angle signal 516 to the inputs receiver 504, indicating the boom 210 has reached its maximum outward position.

In Step 630, the control system 500 may extend the trailing arms 232 in response to a request (e.g., via operator input 512) for the extension of the trailing arm assembly 230. The ECM 502 then generates a trailing arm command 556 to the actuators for the pneumatic system (e.g., while monitoring actuation via signal 522 from pneumatic sensors 240). This may cause the pneumatic system 236 to supply pressurized fluid to the plurality of telescoping links 234 to fully extend the plurality of trailing arms 232. The trailing arms 232 fully extend in a direction generally towards the ground 10 from the distal end of the boom 210, with the connection sockets of links 234 each forming an electrical connection for conducting electrical energy along the length of the telescoping arms 232.

In the fully extended state, the trailing arm assembly 230 is extended to a length, L (FIG. 4) that is greater than distance D₀. Therefore, upon meeting the electrically-conducting rail system 110, the trailing arm assembly 230 rotates rearward, in a direction opposite to direction of the movement of the mobile machine 120, such that the contactor assembly 250 trails behind the boom 210 (FIG. 4). The trailing arm assembly 230 can be extended either while the mobile machine 120 is in motion during operation or when the mobile machine at rest or stopped.

In Step 630, the contactor assembly 250 aligns with the plurality of conductor rails 112. In operation (FIG. 4), a force of gravity acts on the combined masses of the trailing arm assembly 230 and the contactor assembly 250 and a magnetic force generated by the plurality of magnets (not shown) housed within the base frame 256 encourage a connection between the contactor assembly 250 and the plurality of conductor rails 112.

In Step 640, the control system 500 determines whether the trailing arm assembly 230 is aligned with the plurality of conductor rails 112 by sensing the presence of an electrical current and ground in the plurality of conductor rails through the use of the continuity sensors in the contactor assembly 250, as well as the alignment of the rails through the use of the position sensors 238 housed with the plurality of trailing arms 232. To determine the alignment of the trailing arm assembly 230 relative to the rails, position sensors 238 and the continuity sensors provide feedback to the control system 500, which generates the appropriate movement commands as necessary. Position sensors 238 are secured near or within the plurality of trailing arms 232 and provide vertical and horizontal position data to the control system. Once the control system has received the position signal 520, the ECM 502 may generate display data 560 in the form of position indicators 152 for the operator in the cabin 150. The position indicators may include camera images, turn signal indicators for guiding the operator on the positioning of the trailing arm assembly 230, image representations of the connector arm assembly 200 in relation to the electrically-conducting rail system 110, or other suitable representations. Likewise, continuity sensors, specifically the voltage sensors 252 and the ground sensors 254, continuously test for the presence of voltage or ground along the conductor rails and transfer voltage and ground information to the control system.

In step 650, if the contactor assembly 250 is properly aligned with the rails and confirms the presence of an electrical current and ground, the electrical energy carried by the electrically-conducting rail system 110 is transferred from the plurality of conductor rails 112 to the contactor assembly 250, along the trailing arm assembly 230, through the busbar assembly within the boom 210 and to the battery system 134 of the mobile machine 120. The electrical transfer from the conductor rails 112 to the battery system 134 may continue for as long as necessary to either charge the battery system 134 fully or as long as the operator deems necessary.

Step 660 includes determining whether the current or ground connection is missing (e.g., disconnected) and determining whether the ECM 502 received a command to retract the rail connector assembly 200. The determination in Step 660 is “no” when current and ground are connected, as indicated by signals 524 and 526, and no retraction request is received via operator input 512.

However, the determination in Step 660 is “yes” if the connector assembly control system determines that the contactor assembly 250 is not properly aligned with the conductor rails 112 or that an electrical current or ground is not present on the conductor rails 112. Method 600 may then proceed to Step 670, in which the control system 500 generates a contactor assembly command 558 to disengage from the plurality of conductor rails 112. The contactor assembly command 558 signals to the pneumatic system 236 to generate fluid pressure in the plurality of extendable brushes 264, located in the contactor assembly 250, to create a disengaging force that is greater than the magnetic and gravitational forces acting on the contactor assembly. The extendable brushes 264 would extend in a downward direction 268 (FIG. 5) towards the conductor rails 112, with the brush extension 266 thereby disconnecting the electrical connection of the conducting terminals 262 with the rails.

Once the contactor assembly 250 has been disconnected from the conductor rails, Step 680 may be performed by generating a trailing arm command 556 to retract the trailing arm assembly 230 from the fully-extended state (FIG. 4) to the retracted state. Specifically, the trailing arm command 556 signals to the pneumatic system 236 to retract the plurality of trailing arms 232, resulting in the trailing arms 232 being oriented in a vertical direction relative to the ground at the distal end of the boom 210 and the disconnected contactor assembly 250 hanging from the trailing arm assembly above the conductor rails 112, as shown in FIG. 3.

As part of Step 680, the ECM 502 may subsequently or simultaneously generate a boom command 554, signaling to the hydraulic system 214 of the boom 210 to retract the boom from the fully-extended state (FIG. 3) to the retracted state (FIG. 2). The angle sensor 220 communicates with the inputs receiver 504, providing angle signal 516 when the boom has been fully retracted. Once retracted, the lock sensor 216 senses the proximity of the boom 210 and provides a proximity indicator to the control system. The ECM 502 generates a lock command 552 to the locking pin to actuate the locking pin, locking the boom 210 to the side of the mobile machine 120.

In addition to the retraction of the trailing arm assembly 230 and the locking of the boom, Step 680 can include coupling the contactor assembly 250 to the shelf 142. For example, prior to or upon locking the boom 210, the pneumatic sensors 240 in the trailing arm assembly 230 send a pneumatic signal 522 to the inputs receiver 504 to extend the telescoping links 234 of the trailing arm assembly 230. The ECM 502 calculates and generates a trailing arm command 556 that extends the plurality of trailing arms so that the contactor assembly 250 abuts the shelf 142. Once contact has been made, the combined mass of the trailing arm assembly 230 and the contactor assembly 250 and the magnetic force created by the magnets integrated into the base frame 256 effectively couple the contactor assembly 250 to the shelf 142 in the stowed state as shown in FIG. 2.

In accordance with this disclosure, the control system for the rail connector assembly of the mobile machine provides a sequence of conditions and calculations in order to securely and safely connect the mobile machine to the electrically-conducting rail system for charging. Furthermore, the control system provides for the automated deployment and engagement of the connector assembly along any route on an industrial worksite without the need for an operator to manage the deployment. Finally, the control system provides additional safety by continuously testing for the presence of current and a ground and quickly disengaging from the conductor rails when there is a lack of current, a lack of a ground, or if the connector assembly is not properly aligned.

Referring to FIG. 8, another mobile machine or electric machine 10 is shown, which may have any of the features discussed herein in relation to mobile machine power system 100. Machine 10 includes a frame 12 having a front frame end 14 and a back frame end 16. A bed 18 is supported on frame 12 and typically movable between a lowered or loading position and a raised or dumping position as is conventionally known. Ground-engaging elements 20 are coupled to frame 12 and include wheels in the illustrated embodiment. Machine 10 is shown in the context of a mining truck as is well-known and used for transporting ore and overburden in an opencast mine environment. As discussed hereinabove, this disclosure is not thereby limited, however, and other types of machines are within the scope of the present disclosure, including track-type machines, loader machines, motor graders, scrapers, or still others.

Machine 10 includes an electric power system 22 having an electric motor 24 and a battery 26. In an embodiment, electric motor 24 includes an electric drive motor structured to rotate ground-engaging elements 20 for propelling and maneuvering machine 10. Embodiments are contemplated where a single electric drive motor is provided that powers some or all of ground engaging elements 20, as well as embodiments where individual wheel electric motors are used. In still other instances machine 10 could include both a combustion engine and an electric drive motor or multiple electric drive motors, or potentially even a combustion engine for propulsion and electric motors for operating on-board equipment such as pumps, fans, compressors, and other equipment. In a practical implementation machine 10 is 100% electrically powered. While one electrical energy storage device, namely, battery 26, is shown, in many embodiments multiple batteries or multiple battery banks may be carried on-board. As an alternative to or in addition to electric batteries, embodiments are contemplated employing electrical energy storage devices in the nature of capacitors. It will thus be appreciated that machine 10 is described as an electric machine without limitation as to the purpose or extent of electrification of the various machine components.

Machine 10 is shown upon a work surface or substrate 34. Positioned adjacent to machine 10 in FIG. 8 is a power rail 30 including a plurality of parallel conductive lines or bars, at least some of which are electrified by way of electric grid power, on-site electric power generation or storage, et cetera. Power rail 30 may have any of the features discussed herein in relation to electrically-conducting rail system 110. It is contemplated that, at least at times during operation in service, it is desirable to supply electric power to machine 10 from power rail 30 for directly powering electric power system 22 or for charging the one or more batteries 26. To this end, machine 10 may electrically connect to power rail 30 only at certain times during service such as where battery 26 needs to be charged or where it is otherwise desirable to electrically connect electric power system 22 to off-board electric power. One example of the latter scenario is when machine 10 is climbing a haul road and moving upon substrate 34 up a grade out of a mine while loaded with ore, overburden, et cetera. In other instances electric power system 22 may be connected to power rail 30 where machine 10 is traversing a relatively level and straight segment of a travel path between a loading location and a dumping location. The timing, location, duration, and frequency of connections to power rail 30 will depend upon various factors including how machine 10 is used and the design of a mine as well as design of the off-board electrical power system of which power rail 30 is a part. Power rail 30 is shown supported upon stands or the like 32 above substrate 34. In other instances power rail 30 could be supported upon or close to substrate 34, supported by way of horizontal supports, or still another configuration.

To electrically connect electric power system 22 to power rail 30, machine 10 includes a power rail connector 40. Power rail connector 40 is positionable according to multiple degrees of freedom laterally of frame 12 to provide electrical connection between power rail 30 and electric power system 22 at a range of power rail heights, locations relative to machine 10, and to accommodate changes in height, curves, and other variations in location of power rail 30 relative to machine 10. Power rail connector 40 may include electrical cabling 36 that provides electrical power connections between power rail 30 and electric power system 22. Suitable power electronics may be carried onboard machine 10 for purposes of power conditioning and distribution between and among electric motor 24, battery 26, and other electric power system components.

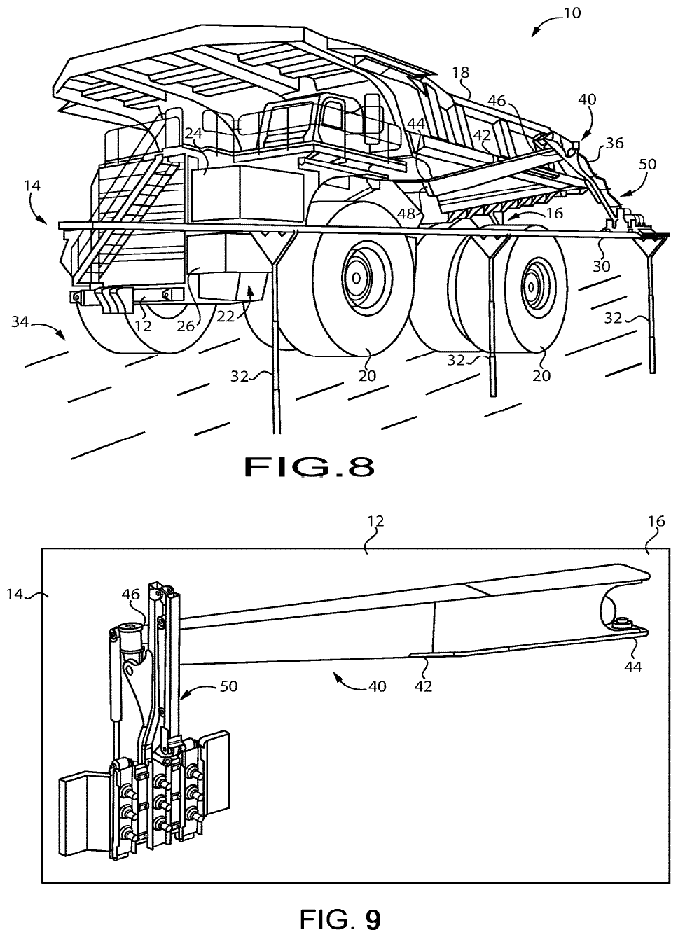

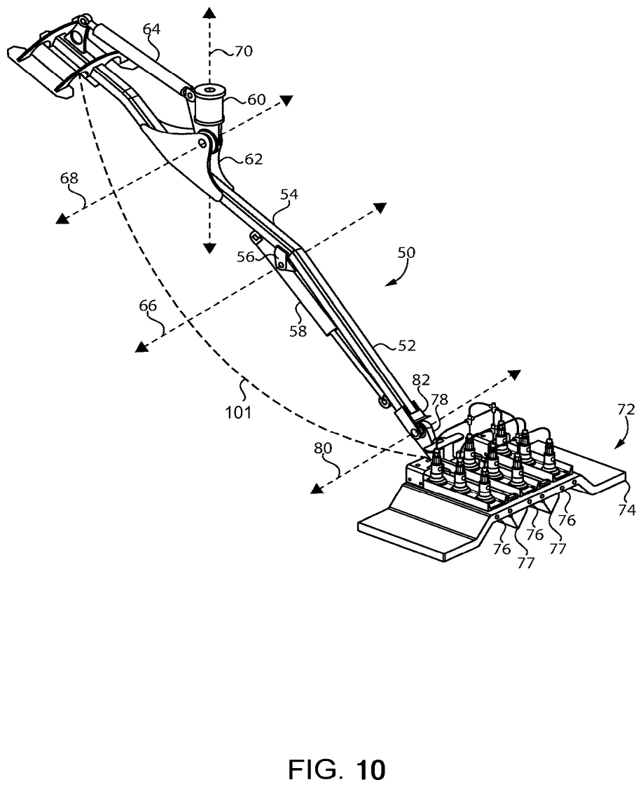

Referring also now to FIGS. 9 and 10, power rail connector 40 includes a linkage 50 having a lower link 52, an upper link 54, and a fold joint 56 connecting lower link 52 to upper link 54. Linkage 50 also includes a fold actuator 58 coupled between upper link 54 and lower link 52, a pivot 60, a lift joint 62 connecting pivot 60 to upper link 54, and a lift actuator 64 coupled between pivot 60 and upper link 54. Power rail connector 40 may also include a horizontally extending support arm 42. Support arm 42 includes an inboard arm end 44 coupled to frame 12, and an outboard arm end 46. Support arm 42 may be movable from a stowed position relative to frame 12, to a service position approximately as shown in FIG. 8 where outboard arm end 46 is spaced laterally outward of frame 12. A pivot 48 may connect inboard arm end 44 to frame 12 or other supporting components. For example, pivot 48 may be coupled to a rollover protection beam or other rollover protection structure part of a rollover protection system (ROPS), which may or may not be a part of frame 12. In an embodiment, support arm 42 can function as a swing arm, swinging out about pivot 48 to the service position as depicted in FIG. 8, and swinging in about pivot 48 to the stowed position approximately as depicted in FIG. 9. Support arm 42 may be coupled with a suitable actuator, such as a hydraulic cylinder, to swing between the stowed position and the service position. Support arm 42 may be pivotable between the stowed position and the extended position, and in alignment fore-aft with frame 12 at the stowed position. As shown in FIG. 8, a first end of support arm 42 may be coupled to frame 12 at pivot 48, and a second end of support arm 42 may be extendable away from machine 10 such that in the service position (shown in FIG. 8) the second end of support arm 42 is vertically above the first end of support arm 42. For example, pivot 48 may be angled by 1-15 degrees offset from a vertical axis to tilt support arm 42 when in the service position. Support arm 42 may also be vertically movable, up and down in the FIG. 8 illustration, in some embodiments. In still other implementations support arm 42 could be telescoping or swing vertically, or movable relative to frame 12 by way of any other suitable strategy or mechanism.

With continued focus on FIG. 10, power rail connector 40 may further include a rail contactor 72 coupled to lower link 52 and including electrical contacts 76 positioned to electrically connect to power rail 30. Rail contactor 72 may include any suitable number of electrical contacts, and as illustrated includes three elongate electrical contacts 76. Electrical contacts 76 may include elongate brushes, for example, extending parallel to one another as in the illustrated embodiment and alternating with a plurality of spacers 77. Any suitable electrical contact configuration and/or material may be used. Rail contactor 72 may be movable in at least 1 degree of freedom relative to lower link 52 and attached to lower link 52 by way of a lower pivot 78. Lower pivot 78 defines a pivot axis 80 that is horizontally extending and enables rail contactor 72 to pivot up and down. In an implementation, a neutral support 82 is coupled to lower pivot 78 and causes rail contactor 72 to generally maintain a fixed orientation relative to lower link 52 unless perturbed. In this manner, during engagement of rail contactor 72 with power rail 30, rail contactor 72 can be expected to seat against power rail 30 with the assistance of its own weight. Rail contactor 72 may include a hat or body 74 supporting electrical contacts 76.

Fold joint 56 defines a horizontally extending fold axis 66. Lift joint 62 defines a horizontally extending lift axis 68. Pivot 60 defines a vertically extending pivot axis 70. Linkage 50 may be adjustable from an extended, current-collecting configuration approximately as shown in FIGS. 1 and 3 to a collapsed configuration approximately as shown in FIGS. 2, 4, and 5, via rotation of lower link 52 relative to upper link 54 about fold axis 66 and rotation of upper link 54 relative to pivot 60 about lift axis 68. In view of the foregoing description, it will be appreciated that power rail connector 40 can be extended by way of moving support arm 42 and deploying linkage 50 to a configuration outboard of frame 12 and electrically contacting power rail 30, and to the collapsed configuration where linkage 50 is retracted for storage and support arm 42 swung back against frame 12. This functionality enables power rail connector 40 to be selectively positioned at a range of locations and orientations relative to frame 12 to successfully electrically connect with power rail 30 in a range of conditions.

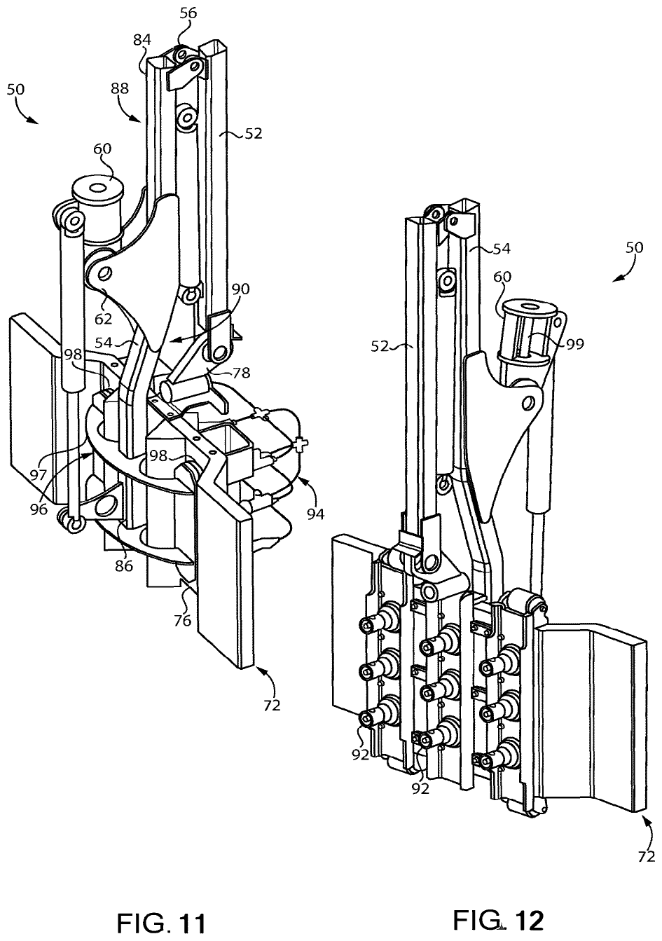

Referring also now to FIGS. 11 and 12, upper link 54 includes a first upper link end 84 attached to fold joint 56, and a second upper link end 86. Lift joint 62 may be attached to upper link 54 at a location between first upper link end 84 and second upper link end 86. Lift actuator 64 may include a linear actuator, such as a hydraulic cylinder, coupled between pivot 60 and second upper link end 86. In an implementation lift actuator 64 is directly attached to pivot 60 and directly attached to second upper link end 86, such as by flanged connections. Fold actuator 58 may also include a linear actuator, such as a hydraulic cylinder, coupled between lower link 52 and upper link 54, and typically attached to the respective upper link 54 and lower link 52 by way of flanged connections. It can further be noted that pivot 60 is located on an upper side 88 of upper link 54. Upper link 54 also includes a lower side 90. Power rail connector 40 may also include a dock 96 mounted to second upper link end 86 and including a plurality of pads 98 located on lower side 90. In the illustrated embodiment dock 96 includes a frame 97 that positions pads 98 to contact rail contactor 72 in the collapsed configuration. Pads 98 may contact rail contactor 72 in an alternating arrangement with the plurality of elongate electrical contacts 76.

Returning to focus on FIG. 10, an arc 101 is defined between dock 96 and rail contactor 72 in the extended, current-collecting configuration. Fold axis 66 may define a vertex of an angle subtended by arc 101. The angle subtended by arc 101 may have a size ranging from about 0° in the collapsed configuration to about 180° in the extended, current-collecting configuration. As used herein, the term “about” can be understood to mean generally or approximately, as would be understood by one of skill in the art, such as within measurement error. It can also be appreciated that rotation of lower link 52 relative to upper link 54 and rotation of upper link 54 relative to pivot 60 may both be a counterclockwise rotation. Thus, in the view of FIG. 10 lower link 52 is understood to rotate counterclockwise about fold axis 56 and upper link 54 understood to rotate counterclockwise about lift axis 68 when linkage 50 is adjusted from the extended, current-collecting configuration to the collapsed configuration.

Focusing now briefly on FIG. 12, there can be seen electrical connectors 92 that electrically connect to electrical contacts 76. Wiring 94 as shown in FIG. 11 can electrically connect electrical contacts 76 to cabling 36. Also shown in FIG. 12 is a pivot pin 99 within pivot 60. Pivot pin 99 or another suitable rotatable structure may be positioned within pivot 60 and attached to horizontally extending support arm 42 enabling linkage 50 to pivot in a range of angular orientations relative to support arm 42.

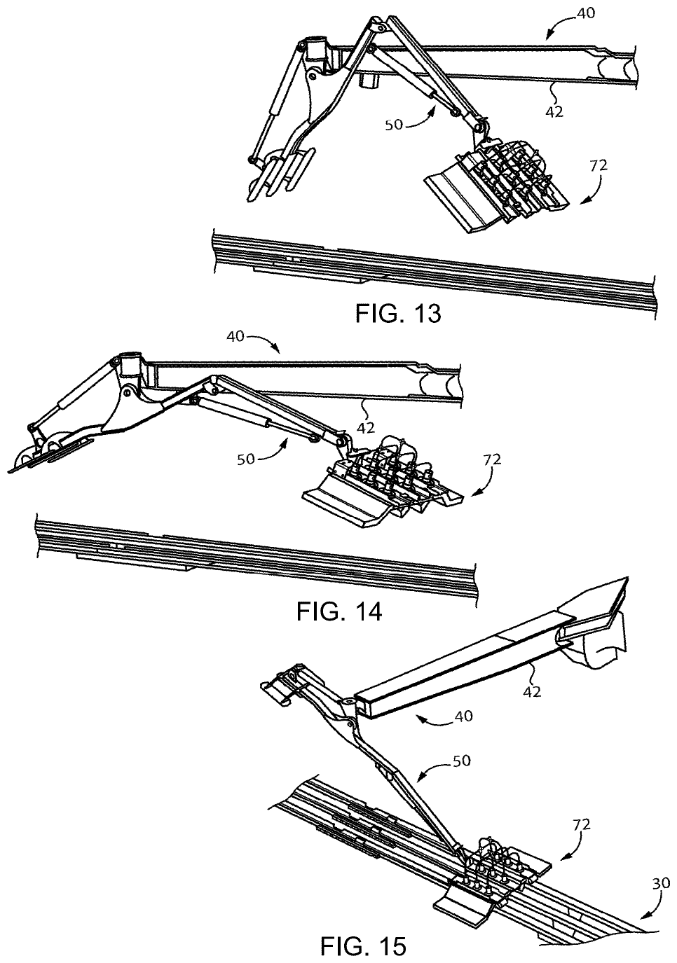

Referring to the drawings generally, but also now focusing on FIGS. 13, 14, and 15, when machine 10 is moved in proximity to power rail 30, typically moving generally parallel along power rail 30, and it is desirable to initiate connecting electric power system 22 to power rail 30, support arm 42 may be moved from a stowed position toward a service position extending outboard from frame 12. With support arm 42 appropriately positioned, or during the positioning of support arm 42, linkage 50 may be adjusted from a collapsed configuration to the extended, current-collecting configuration via unfolding linkage 50 at fold joint 56, and lowering linkage 50 at lift joint 62. Rail contactor 72 may be aligned laterally with power rail 30, based on an at least one of an angular orientation of linkage 50 about pivot axis 70 relative to support arm 42 or a lateral position of support arm 42 relative to frame 12. It will thus be appreciated that support arm 42 can be positioned at a range of locations and orientations relative to frame 12, and linkage 50 can be positioned at a range of angular orientations about pivot axis 70 to position rail contactor 72 above power rail 30. Linkage 50 may be fully extended and lowered to contact rail contactor 72 to power rail 30 to electrically connect electric power system 22 in machine 10 to power rail 30. While connected to power rail 30, a weight of linkage 50 may be supported by the attachment of pivot 60 to support arm 42 and by resting upon power rail 30 itself.

As discussed above, adjusting linkage 50 in this manner may occur during moving machine 10 along power rail 30. Stopping machine 10 to achieve the desired electrical connection would nevertheless be within the scope of the present disclosure. With rail contactor 72 electrically connected to power rail 30, machine 10 can operate with electric power supplied via power rail 30, directly powering onboard electrical equipment such as electric motor 24, charging battery 26, or both. When it is desirable to end electrical connection to power rail 30, such as where machine 10 reaches an end of power rail 30 near the end of an uphill grade, where battery 26 is fully charged, or for other reasons such as maneuvering machine 10 away from power rail 30, linkage 50 can be adjusted back to the collapsed configuration, contacting rail contactor 72 to dock 96 in the collapsed configuration. Support arm 42 can be rotated back to the stowed position, and machine operation continue using on-board electrical power.

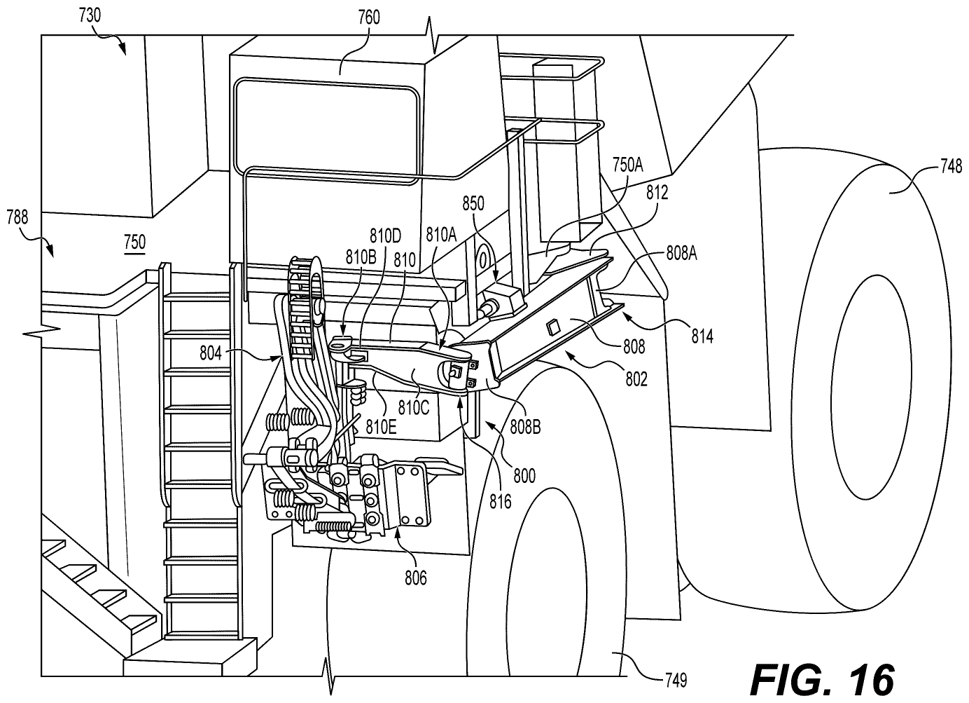

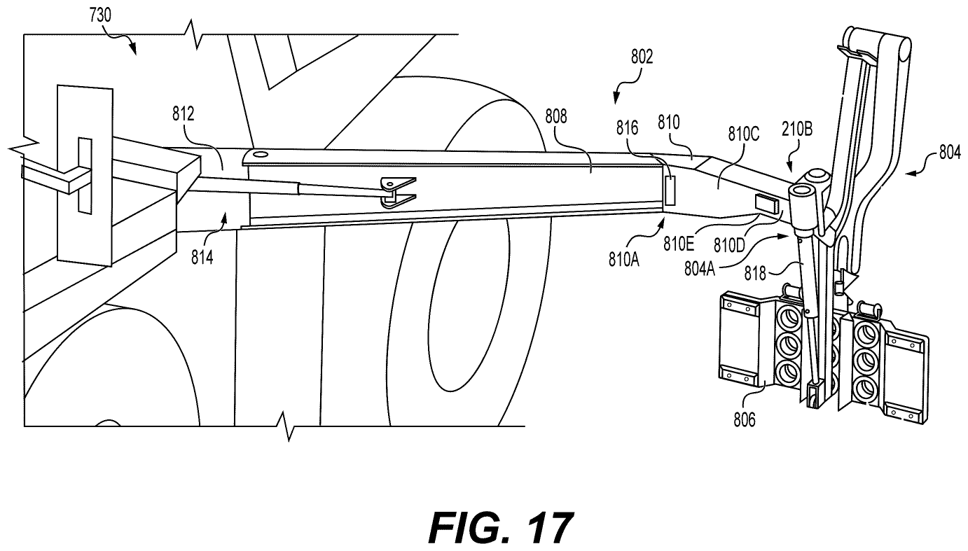

FIGS. 16 and 17 illustrate a boom assembly 802 that may be a two-part boom assembly, including a main boom 808 and a boom tip 810. Although referred to as a boom assembly 802 in FIG. 16, any of the features of rail connector assembly 200 and power rail connector 40, including trailing arm assembly 230 and linkage 50, may be considered part of a boom assembly for purposes of this disclosure, and any of the features of rail connector assembly 200 and power rail connector 40 may be incorporated in boom assembly 802.

A first or proximal end 808A of main boom 808 may be coupled to a portion of a mobile machine frame 750, for example, via a boom bracket 812. Mobile machine frame 750, and any other frame 140, 12 described herein, may include one or more frame members. Boom assembly 802 may be pivotable or rotatable relative to machine frame 750 via one or more pivotable connections 814 between proximal end 808A of main boom 808 and boom bracket 812. As discussed in detail below, boom assembly 802 may be secured to another portion of machine frame 750 via one or more boom lock assemblies 850. Boom bracket 812 is shown as being mounted to machine frame 750 such that main boom 808 pivots about a vertical axis or an axis offset from the vertical axis by 1-15 degrees. Boom bracket 812 may be fixedly coupled to two planar surfaces of frame 750, and each of these planar surfaces of frame 750 may be transverse from each other. For example, boom bracket 812 may be coupled to a rollover prevention structure on one side of boom bracket 812 and may be coupled to another structure of frame 750 on another side of boom bracket 812 such that boom bracket 812 is positioned at a corner portion of frame 750 formed by the two planar surfaces of frame 750. However, this disclosure is not so limited, and boom bracket 812 may be mounted to or otherwise coupled to machine frame 750 in other configurations and/or main boom 808 may otherwise be pivotable relative to boom bracket 812 and/or machine frame 750.

Boom assembly 802 may be attached to a side surface 750A (e.g., a lateral side and/or parallel to a direction of travel of machine 730) of frame 750 to pivot or rotate about a joint or pivotable connection(s) 814. In other examples, boom bracket 812 may be coupled to a front portion of mobile machine 730 and boom assembly 802 may extend along a front portion of mobile machine 730 in a stored or retracted configuration. In some examples, boom bracket 812 may be coupled to a rollover protection structure such as a rollover protection beam, which may or may not be part of machine frame 750. Although boom assembly 802 is shown to be attached to a mining haul truck, boom assembly 802 is capable of being incorporated in various types of mobile machines, as boom bracket 812 may be an interchangeable adapter that is specific to the type of machine being operated.

Additionally, a second or distal end 808B of main boom 808 (i.e., opposite to first or proximal end 808A) may be coupled to boom tip 810. For example, boom tip 810 may be pivotably or rotatably connected to distal end 808B of main boom 808 via another pivotable connection 816 (e.g., a pivotable boom connection) between distal end 808B of main boom 808 and boom tip 810 (e.g., a proximal end 810A of boom tip 810). One or more of pivotable connection 814 and pivotable boom connection 816 may be hydraulically, electrically, and/or pneumatically controlled, for example, to control the position of main boom 808 relative to boom bracket 812 and machine frame 750 and/or the position of boom tip 810 relative to main boom 808. Alternatively or additionally, one or more of pivotable connection 814 and pivotable boom connection 816 may be controlled via one or more motors (not shown). In some aspects, a rotary actuator (e.g., between main boom 808 and boom tip 810) may control the position of boom tip 810 relative to main boom 808, for example, forming an adjustable knuckle joint.

As mentioned, boom tip 810 includes proximal end 810A. Additionally, boom tip 810 includes a distal end 810B, for example, opposite to proximal end 810A. As shown, in some aspects, boom tip 810 includes an angled portion 810C extending between proximal end 810A and distal end 810B. For example, angled portion 810C may extend upward at a non-zero angle (e.g., between approximately 15 degrees to approximately 75 degrees, between approximately 30 degrees and approximately 60 degrees, for example, approximately 45 degrees) from a longitudinal axis of main boom 808 and pivotable boom connection 816. In some aspects, the angle that angled portion 810C extends from the longitudinal axis of main boom 808 may be adjustable. Moreover, boom tip 810 may include an end portion 810D, for example, distal of angled portion 810C. End portion 810D may extend parallel to the longitudinal axis of main boom 808 and pivotable boom connection 816. As a result, boom tip 810 may include a bent portion 810E, for example, formed by the coupling of angled portion 810C to end portion 810D.

Additionally, trailing arm assembly 804 may be coupled to boom tip 810, for example, to distal end 810B of boom tip 810. For example, a proximal end 804A of trailing arm assembly 804 may be coupled to distal end 810B of boom tip 810, for example, via a rotatable or pivotable connection 818 (FIG. 17). Rotatable or pivotable connection 818 may be configured to transition trailing arm assembly 804 between two or more configurations relative to boom tip 810, for example, between at least a folded or stowed configuration (FIG. 16) and an unfolded or extended configuration (FIG. 17). A rail contactor 806 may be coupled to a distal portion of the trailing arm assembly 804.

Referring to FIG. 16, boom assembly 802 is shown in a retracted or stowed configuration, with main boom 808 extending along a side portion of mobile machine 730 and boom tip 810 extending along a front portion of mobile machine 730. Boom tip 810 is positioned pivoted relative to main boom 808 such that boom tip 810 extends outward from pivotable connection 816 at a substantially ninety degree or right angle relative to a longitudinal axis of main boom 808. Boom assembly 802 is shown extending around a corner portion 800 of mobile machine 730, and pivotable connection 816 allows boom assembly 802 to extend around this corner portion 800 of mobile machine 730. Main boom 808 is shown coupled to mobile machine 730 between a front ground-engaging element 749, such as a front tire, and the operator cabin 760 of mobile machine 730, and also entirely in front of a rear ground-engaging element 748. Although pivotable connection 816 is shown coupled to a side surface 750A of mobile machine 730, pivotable connection 816 may be coupled to a front portion of mobile machine 730. As shown in FIG. 16, boom assembly 802 may be positioned below a walkway 788 of mobile machine 730, and, in some examples, walkway 788 may be substantially co-planar with a floor of operator cabin 760. In a fully retracted configuration, trailing arm assembly 804 may be entirely in front of the operator cabin 760, and may be stored adjacent to a front portion of mobile machine 730, for example in front of walkway 788. In some examples, trailing arm assembly 804 may be entirely in front of a front ground engaging element 749 when in a fully retracted configuration.

FIG. 17 illustrates boom assembly 802 in an extended configuration, with main boom 808 extending laterally outward from a side of mobile machine 730. As shown in FIG. 17, main boom 808 may be angled upward in the extended configuration, with boom connection 816 positioned vertically higher than pivotable connection 814. Although boom assembly 802 is shown as with boom tip 810 pivotable relative to main boom 808, boom assembly 802 is not so limited and may include any number of suitable components pivotable relative to each other, such as include two main booms 808 pivotable relative to each other and also a boom tip 810 pivotable relative to one of the two main booms 808.

The position where boom assembly 802 is coupled to mobile machine 730 is significant because boom assembly 802 may be heavy, such as more than a ton, and coupling such a heavy assembly to a mobile machine presents unique challenges. For example, coupling boom assembly 802 to mobile machine 730 may cause damage to mobile machine 730 if the structure of mobile machine 730 cannot hold the weight of boom assembly 802. Also, mobile machine 730 may have reduced carrying capacity due to coupling boom assembly 802 to mobile machine 730, which may increase the likelihood of failure of one or more components of mobile machine 730. In addition, coupling boom assembly 802 to mobile machine 730 may cause mobile machine 730 to be off balance, may prevent effective engagement of ground-engaging elements 749 with the ground, and may cause mobile machine 730 to be unsafe for operation. The specific positions of boom assembly 802, and rail connector assembly 200 and power rail connector 40, shown in this disclosure are designed to optimize operation of mobile machines 120, 10, 730, 900 and reduce the risk of machine failure during operation of the machine.

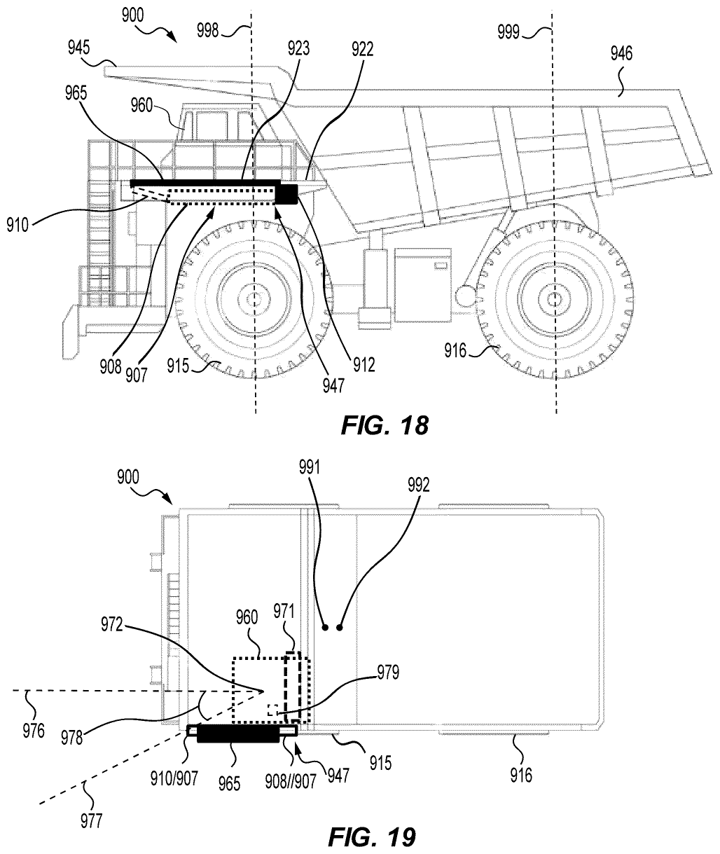

FIGS. 18 and 19 illustrate side and top views, respectively, of a mobile machine 900 including a boom assembly 907. Boom assembly 907 is shown including a main boom 908, a boom tip 910, and a bracket 912 pivotably coupled to a proximal end of the main boom 908. In FIG. 18, boom assembly 907 is shown coupled to mobile machine 900 between a front ground engaging element 915 (e.g., a front tire) and operator cabin 960, and specifically main boom 908 is positioned vertically between ground engaging element 915 and operator cabin 960. In some examples, boom assembly 907 may be positioned between a front ground engaging element 915 and a canopy 945 of the mobile machine 900, and in some examples may be positioned above walkway 922. Canopy 945 may be formed as part of (shown in FIG. 18) or separate from a truck bed portion 946 of mobile machine 900. Canopy 945 may cover a portion of a walkway 922 of mobile machine 900 and, in some examples, may cover operator cabin 960. In some examples, as shown in FIG. 18, boom assembly 907 may be positioned entirely below a floor 923 of operator cabin 960. Main boom 908 and/or boom tip 910 may be positioned entirely in front of operator cabin 960 when boom assembly 907 is in a fully retracted configuration (or stowed configuration). As shown in FIG. 18, boom assembly 907 may be positioned at least 8 feet from the ground, and either the entirety of boom assembly 907 may be positioned at least 8 feet from the ground or at least a portion of boom assembly 907 may be positioned at least 8 feet from the ground in both the fully extended and fully retracted position.

In some examples, bracket 912 and/or a proximalmost end 947 of main boom 908 may be coupled to mobile machine 900 at a position between a first vertical axis 998 extending through a center of a front ground engaging element 915 and a second vertical axis 999 extending through a center of a rear ground engaging element 916. By coupling main boom 908 to mobile machine 900 at a position between first vertical axis 998 and second vertical axis 999, the weight of boom assembly 907 may be distributed more effectively across both rear ground engaging member 916 and front ground engaging member 915, may facilitate maintaining stability during operation of mobile machine 900, and may facilitate rollover prevention. Also, by positioning boom assembly 907, and specifically bracket 912 and/or a proximalmost end 947 of main boom 908, directly above front ground engaging member 915 may facilitate maintaining stability during operation of mobile machine 900 and may facilitate rollover prevention.

A cover 965 is shown in FIGS. 18 and 19 coupled to a portion of mobile machine 900. Cover 965 may be positioned adjacent to boom assembly 907 when boom assembly 907 is in a fully retracted (e.g., stored) position. Cover 965 may extend over at least a portion of boom assembly 907 to cover boom assembly 907 and protect boom assembly 907 from debris, such as falling rocks, during operation of mobile machine 900. FIG. 19 illustrates cover 965 extending over boom assembly 907 when boom assembly 907 is in a fully retracted position.

FIG. 19 illustrates a top view of mobile machine 900, with operator cabin 960 and a rollover prevention beam 971 shown in dotted lines to designate their relative position on mobile machine 900. As shown in FIG. 19, boom assembly 907 may be directly coupled to rollover prevention beam 971, for example at proximalmost end 947 of main beam 908 via bracket 912. Proximalmost end 947 of main beam 908 is shown coupled to mobile machine 900 at a position adjacent to a rear portion of operator cabin 960, however proximalmost end 947 of main beam 908 may be positioned entirely rearward of or behind operator cabin 960. For example, proximalmost end 947 may be mounted directly behind operator cabin 960. An inverter cabinet 979, which may be part of a power system of mobile machine 900 such as power system 22, may be positioned adjacent to the proximalmost end 947 of main beam 908, which may facilitate routing electrically wiring of boom assembly 907 and mobile machine 900. Inverter cabinet 979 may be located along a straight line path with proximalmost end 947. Although shown as inverter cabinet 979, inverter cabinet 979 may be any other portion of a power system for mobile machine 900, such as a portion of a battery. A center of mass 991 is shown in FIG. 19, and proximalmost end 947 of main beam 908 may be mounted to mobile machine 900 within 10% of center of mass 991. In some examples, the center of mass 991 may be the average position of all the parts of the mobile machine 900, weighted according to their masses. By coupling main beam 908 close to center of mass 991, mobile machine 900 may maintain stability with the additional weight of boom assembly 907. A center of rotation 992 is shown in FIG. 19, and proximalmost end 947 of main beam 908 may be mounted to mobile machine 900 within 10% of a center of rotation 992 of the mobile machine 900. By coupling boom assembly 907 close to the center of rotation 992 of mobile machine 900, mobile machine 900 may maintain stability with the additional weight of boom assembly 907 while mobile machine 900 is turning during operation. In some examples, the center of rotation 992 may be an Instantaneous Center of Rotation (ICR) that is located on the intersection point between lines perpendicular to the direction of the wheels (or ground engaging elements) of the mobile machine.

A longitudinally extending front axis 976 is shown extending from a center point 972 within operator cabin 960. The positioning of boom tip 910 relative to front axis 976 is shown by axis 977, which forms an angle 978 with front axis 976. Axis 977 is shown extending from center point 972 through a portion of boom tip 910. Boom assembly 907 may be positioned on mobile machine 900 such that the angle formed between front axis 976 and axis 977 is between 70 and 110 degrees, or 110 degrees or greater. In other examples, boom assembly 907 may be positioned on mobile machine 900 such that the angle formed between front axis 976 and axis 977 is any other suitable angle. Angle 978 may be configured such that boom assembly 907 is positioned within a field of view of an operator in operator cabin 960 during operation of mobile machine 900. In some examples, an operator's field of view may be about 110-130 degrees to both sides of front axis 976. In other examples, angle 978 may be configured such that boom assembly 907 is positioned outside a field of view of an operator in operator cabin 960 during operation of mobile machine 900 (e.g., outside the field of view of the operator in the operator cabin 960 while the operator is looking directly in front or frontward of mobile machine 900).

The specific positions of boom assemblies 802, 907, rail connector assembly 200, and power rail connector 40, including trailing arm assembly 230 and linkage 50, relative to mobile machines 120, 10, 730, 900 are specifically designed to: allow normal operation of mobile machines 120, 10, 730, 900; facilitate machine balancing; provide efficient storage of components of machines 120, 10, 730, 900; provide sufficient strength, rigidity, and integrity of boom assemblies 802, 907, rail connector assembly 200, and power rail connector 40, including trailing arm assembly 230 and linkage 50 to allow effective operation; facilitate serviceability of boom assemblies 802, 907, rail connector assembly 200, and power rail connector 40, including trailing arm assembly 230 and linkage 50; and increase compatibility with various charging infrastructure.

It will be apparent to those skilled in the art that various modifications and variations can be made to the disclosed system without departing from the scope of the disclosure. Other embodiments of the system will be apparent to those skilled in the art from consideration of the specification and practice of the system disclosed herein. It is intended that the specification and examples are considered as exemplary only, with a true scope of the disclosure being indicated by the following claims and their equivalents.

What is claimed is:

1. A mobile machine power conductor linkage for receiving power from a power conductor rail assembly, comprising:
a movable conductor arm assembly including:
a proximal portion including a first proximal end pivotably coupled to a mobile machine and a first distal end, and
a distal portion including (i) a second proximal end pivotably coupled to the first distal end of the proximal portion and (ii) a second distal end extendable away from a side of the mobile machine, the side of the mobile machine being located between a front end and a rear end of the mobile machine; and
the movable conductor arm assembly being movable between a retracted position and an extended position.

2. The mobile machine power conductor linkage of claim 1, wherein the second distal end is positioned above the second proximal end.

3. The mobile machine power conductor linkage of claim 1, wherein:
in the retracted position, the proximal portion extends longitudinally along the side of the mobile machine and the distal portion extends along a front of the mobile machine.

4. The mobile machine power conductor linkage of claim 1, wherein the proximal portion is pivotably coupled to the side of the mobile machine.

5. The mobile machine power conductor linkage of claim 4, wherein the proximal portion is pivotably coupled to the side of the mobile machine at a position longitudinally between a first center point of a front wheel of the mobile machine and a second center point of a back wheel of the mobile machine.

6. The mobile machine power conductor linkage of claim 1, wherein the proximal portion is pivotably coupled to a front portion of the mobile machine, wherein the front portion of the mobile machine is any portion distal of a center of a front wheel of the mobile machine.

7. The mobile machine power conductor linkage of claim 1, wherein the distal portion pivots about a vertical axis relative to the proximal portion.

8. The mobile machine power conductor linkage of claim 1, wherein the first distal end of the proximal portion is positioned vertically higher when in the extended position compared to the retracted position.

9. The mobile machine power conductor linkage of claim 1, wherein the movable conductor arm assembly extends around a corner of the mobile machine in the retracted position.

10. The mobile machine power conductor linkage of claim 1, wherein a portion of the movable conductor arm assembly is positioned within a cover in the retracted position, wherein the cover is configured to extend at least partially over the portion of the moveable conductor arm assembly.

11. The mobile machine power conductor linkage of claim 1, wherein the proximal portion is coupled to a portion of a frame member of the mobile machine.

12. The mobile machine power conductor linkage of claim 1, wherein a portion of the moveable conductor arm assembly is positioned at least eight feet above a ground level in the extended position and the retracted position.

13. The mobile machine power conductor linkage of claim 1, wherein the movable conductor arm assembly is a boom assembly, and the mobile machine power conductor linkage further comprises:
a trailing arm coupled to the boom assembly, and
a contactor assembly coupled to the trailing arm.

14. A mobile machine power conductor linkage for receiving power from a power conductor rail assembly, comprising:
a movable conductor arm assembly including:
a proximal portion including a first proximal end pivotably coupled to a mobile machine and a first distal end, wherein the first proximal end is pivotably coupled to a portion of the mobile machine longitudinally between a center of a front wheel and a center of a rear wheel, and the movable conductor arm assembly being movable between a retracted position and an extended position,
wherein the movable conductor arm assembly is extended away from a side of the mobile machine in the extended position, the side of the mobile machine being located between a front end and a rear end of the mobile machine.

15. The mobile machine power conductor linkage of claim 14, wherein the first proximal end is:
mounted to the mobile machine within 10% of a center of mass of the mobile machine, or
mounted to the mobile machine within 10% of a center of rotation of the mobile machine.

16. The mobile machine power conductor linkage of claim 14, wherein the first proximal end is coupled to at least one of: (i) a portion of the mobile machine directly behind an operator cabin, or (ii) a portion of the mobile machine underneath the operator cabin; or
wherein the movable conductor arm assembly is positioned adjacent to at least one walkway of the mobile machine when in the retracted position.

17. The mobile machine power conductor linkage of claim 14, wherein the movable conductor arm assembly is a boom assembly, and the mobile machine power conductor linkage further comprises:
a trailing arm coupled to the boom assembly, and
a contactor assembly coupled to the trailing arm.

18. The mobile machine power conductor linkage of claim 14, wherein the first proximal end is pivotably coupled to a portion of the mobile machine vertically above the front wheel.

19. The mobile machine power conductor linkage of claim 14, wherein the first proximal end is directly and pivotably coupled to a roll-over-protection beam of the mobile machine.

20. The mobile machine power conductor linkage of claim 14, wherein the first proximal end is located in a straight line path to an inverter cabinet of the mobile machine.

21. A mobile machine power conductor linkage for receiving power from a power conductor rail assembly, comprising:
a movable conductor arm assembly including:
a proximal portion including a first proximal end pivotably coupled to a mobile machine and a first distal end, wherein the first proximal end is pivotably coupled to a portion of the mobile machine vertically between at least one tire of the mobile machine and a floor of an operator cabin, the movable conductor arm assembly being movable between a retracted position and an extended position,
wherein the movable conductor arm assembly is extended away from a side of the mobile machine in the extended position, the side of the mobile machine being located between a front end and a rear end of the mobile machine.

22. The mobile machine power conductor linkage of claim 21, wherein a length of the proximal portion is between three and six meters.

23. The mobile machine power conductor linkage of claim 21, wherein the movable conductor arm assembly weighs over a ton.

24. The mobile machine power conductor linkage of claim 21, wherein the proximal portion is coupled to the mobile machine via a bracket, and wherein the bracket abuts at least two planar surfaces of the mobile machine.

25. The mobile machine power conductor linkage of claim 21, wherein a hydraulic power unit is located inside the proximal portion.

26. The mobile machine power conductor linkage of claim 21, wherein the movable conductor arm assembly further comprises a distal portion, and wherein:
the distal portion includes a second distal end and a second proximal end,
the second distal end is positioned vertically higher than the second proximal end,
the second proximal end is pivotably coupled to the first distal end, and
the proximal portion is substantially straight.

27. A mobile machine power conductor linkage for receiving power from a power conductor rail assembly, comprising:
a movable conductor arm assembly including:
a proximal portion including a first proximal end pivotably coupled to a mobile machine and a first distal end, the movable conductor arm assembly being movable between a retracted position and an extended position,
wherein the movable conductor arm assembly is extended away from a side of the mobile machine in the extended position, the side of the mobile machine being located between a front end and a rear end of the mobile machine, and wherein the first distal end is vertically higher than the first proximal end in the extended position.

28. The mobile machine power conductor linkage of claim 27, wherein the moveable conductor arm assembly further comprises:
a distal portion including a second proximal end pivotably coupled to the first distal end and a second distal end, wherein the second distal end is higher than the second proximal end, wherein the proximal portion is substantially straight.

29. The mobile machine power conductor linkage of claim 27, wherein the proximal portion is substantially straight and forms a 5-10 degree angle with a horizontal axis of the mobile machine when in the extended position.

30. The mobile machine power conductor linkage of claim 27, wherein the proximal portion is 3-6 meters long.

31. The mobile machine power conductor linkage of claim 27, wherein the movable conductor arm assembly is a boom assembly, and the mobile machine power conductor linkage further comprises:
a trailing arm coupled to the boom assembly, and
a contactor assembly coupled to a distal portion of the trailing arm.
